(19) United States
(12) Patent Application Publication
(10) Pub. No.: US 2019/0317999 A1
(43) Pub. Date: Oct. 17, 2019

(54) IDENTIFICATION OF NEW CONTENT WITHIN A DIGITAL DOCUMENT

(71) Applicant: INTERNATIONAL BUSINESS MACHINES CORPORATION, Armonk, NY (US)

(72) Inventors: Patrick K. McNeillie, Campbell, CA (US); Denilson Nastacio, Apex, NC (US); Vadim Raskin, Boeblingen (DE); Ronak Sumbaly, Seattle, WA (US)

(21) Appl. No.: 15/953,642

(22) Filed: Apr. 16, 2018

(51) Int. Cl. G06F 17/28; G06F 17/30; G06N 99/00

(52) U.S. Cl. CPC G06F 17/28; G06F 17/30958; G06N 5/04; G06N 99/005; G06F 17/30011

(57) ABSTRACT

A computer-implemented method for electronically identifying new content in a digital document. The method includes receiving a digital document, utilizing a NLP pipeline to identify one or more articles of subject matter content, together with their respective relationships, contained within the digital document. The method further includes generating, by the NLP pipeline, a knowledge graph, based on the one or more relationships between the one or more articles of subject matter content contained within the digital document, and comparing the generated knowledge graph to one or more stored knowledge graphs based on a novelty-criteria, to determine whether the identified one or more articles of subject matter content, together with their respective relationships, are represented in the one or more stored knowledge graphs. The method further includes communicating one or more portions of the digital document that were determined to not be contained within the one or more stored knowledge graphs.

### BACKGROUND

Embodiments of the present invention relate generally to the field of computing and more particularly to data processing and identification of new content within a digital document.

We live in an age of shared digital information. Medical researchers from every continent, in various fields of study, present their findings in digital journals, online blogs, and other online sources of digital communication on a daily basis. The number of formal and informal publishers for each domain, or subject, oftentimes outpaces the ability of a domain expert to keep up with all digital materials being published. In order to cope with the volume of information on a daily basis, a domain expert must focus on a smaller amount of materials to read, which introduces the risk of ignoring sources of information that are more likely to contain actual novel, or new, content.

The current mechanisms to address the prioritization of knowledge acquisition for a domain expert involve manual searches and choices that are, by nature, inconsistent and incomplete, entailing effort-bound exercises where the experts find a set of documents that may not have the optimal, or even sufficient, volume and quality to meet their goals.

### SUMMARY

Embodiments of the invention include a method, computer program product, and system, for electronically identifying new content in a digital document.

A method, according to an embodiment, for electronically identifying new content in a digital document, includes receiving a digital document, utilizing a natural language processing (NLP) pipeline to identify one or more articles of subject matter content contained within the digital document, and utilizing the NLP pipeline to identify one or more relationships between the one or more articles of subject matter content contained within the digital document. The method further includes generating, by the NLP pipeline, a knowledge graph, wherein the knowledge graph electronically depicts the one or more relationships between the one or more articles of subject matter content contained within the digital document, and comparing the generated knowledge graph to one or more stored knowledge graphs based on a novelty-criteria, to determine whether the identified one or more articles of subject matter content contained within the digital document and the identified one or more relationships between the one or more articles of subject matter content contained within the digital document are represented in the one or more stored knowledge graphs. The method further includes communicating one or more portions of the digital document that were determined to not be contained within the one or more stored knowledge graphs.

A computer program product, according to an embodiment of the invention, includes a non-transitory tangible storage device having program code embodied therewith. The program code is executable by a processor of a computer to perform a method. The method includes receiving a digital document, utilizing a natural language processing (NLP) pipeline to identify one or more articles of subject matter content contained within the digital document, and utilizing the NLP pipeline to identify one or more relationships between the one or more articles of subject matter content contained within the digital document. The method further includes generating, by the NLP pipeline, a knowledge graph, wherein the knowledge graph electronically depicts the one or more relationships between the one or more articles of subject matter content contained within the digital document, and comparing the generated knowledge graph to one or more stored knowledge graphs based on a novelty-criteria, to determine whether the identified one or more articles of subject matter content contained within the digital document and the identified one or more relationships between the one or more articles of subject matter content contained within the digital document are represented in the one or more stored knowledge graphs. The method further includes communicating one or more portions of the digital document that were determined to not be contained within the one or more stored knowledge graphs.

A computer system, according to an embodiment of the invention, includes one or more computer devices each having one or more processors and one or more tangible storage devices; and a program embodied on at least one of the one or more storage devices, the program having a plurality of program instructions for execution by the one or more processors. The program instructions implement a method. The method includes program instructions for receiving a digital document, utilizing a natural language processing (NLP) pipeline to identify one or more articles of subject matter content contained within the digital document, and utilizing the NLP pipeline to identify one or more relationships between the one or more articles of subject matter content contained within the digital document. The method further includes program instructions for generating, by the NLP pipeline, a knowledge graph, wherein the knowledge graph electronically depicts the one or more relationships between the one or more articles of subject matter content contained within the digital document, and comparing the generated knowledge graph to one or more stored knowledge graphs based on a novelty-criteria, to determine whether the identified one or more articles of subject matter content contained within the digital document and the identified one or more relationships between the one or more articles of subject matter content contained within the digital document are represented in the one or more stored knowledge graphs. The method further includes program instructions for communicating one or more portions of the digital document that were determined to not be contained within the one or more stored knowledge graphs.

### BRIEF DESCRIPTION OF THE SEVERAL VIEWS OF THE DRAWINGS

FIG. 1 illustrates a computing environment, in accordance with an embodiment of the present invention.

FIG. 2 is a flowchart illustrating the operation of a new content identifier program, in accordance with an embodiment of the present invention.

FIG. 3 depicts an illustrative example knowledge graph, in accordance with an embodiment of the present invention.

FIG. 4 depicts the hardware components of the computing environment of FIG. 1, in accordance with an embodiment of the present invention.

FIG. 5 depicts a cloud computing environment, in accordance with an embodiment of the present invention.

FIG. 6 depicts abstraction model layers of the illustrative cloud computing environment of FIG. 5, in accordance with an embodiment of the present invention.

### DETAILED DESCRIPTION

The present invention addresses the prioritization of knowledge acquisition for domain experts, which aims at prioritizing reading material (i.e. periodicals, journals, etc.) in terms of their potential of actually expanding the knowledge base of a given reader, relative to a baseline reference represented by a pre-existing body of knowledge.

The pre-existing body of knowledge may range from personal to collective knowledge, which allows the prioritization to be tuned to a particular goal. For example, those goals may be as simple as the originally stated intention of aiding someone's personal education or as complex as identifying new content for a training corpus relating to a project that relies on cognitive computing.

The present invention evolves around using a model annotator to identify entities and relations in unstructured text and then comparing the extracted information with similar extracted information from pre-defined document sets. The invention then assesses a metric of novelty in the new source material relative to those pre-defined sets, and communicates the findings to a user by using standard distribution mechanisms.

Hereinafter, exemplary embodiments of the present invention will be described in detail with reference to the attached drawings.

The present invention is not limited to the exemplary embodiments below, but may be implemented with various modifications within the scope of the present invention. In addition, the drawings used herein are for purposes of illustration, and may not show actual dimensions.

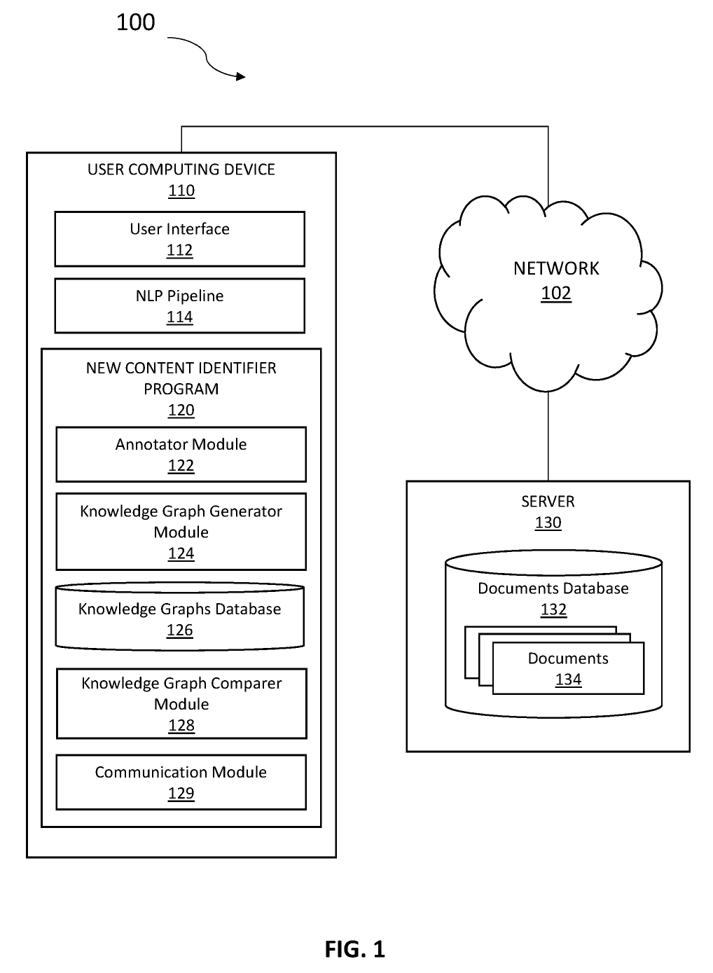

FIG. 1 illustrates computing environment 100, in accordance with an embodiment of the present invention. Computing environment 100 includes user computing device 110 and server 130 connected via network 102. The setup in FIG. 1 represents an example embodiment configuration for the present invention, and is not limited to the depicted setup in order to derive benefit from the present invention.

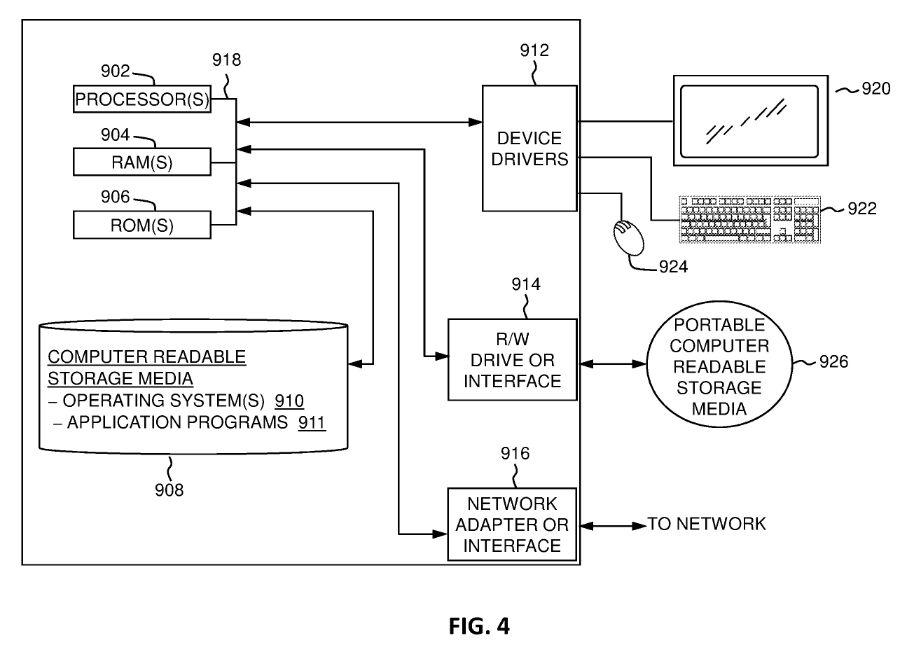

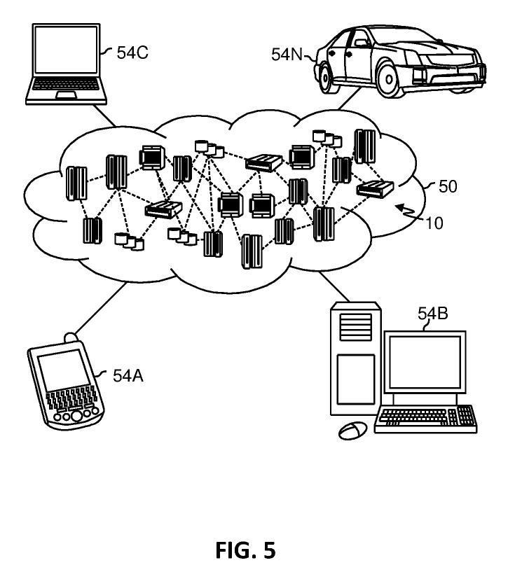

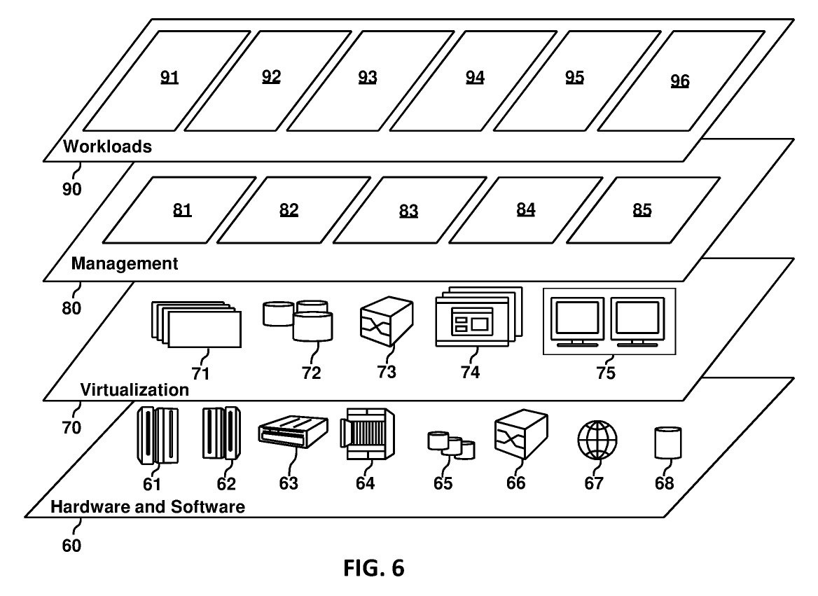

In the example embodiment, user computing device 110 contains user interface 112, natural language processing (NLP) pipeline 114, and new content identifier program 120. In various embodiments, user computing device 110 may be a laptop computer, tablet computer, netbook computer, personal computer (PC), a desktop computer, a personal digital assistant (PDA), a smart phone, or any programmable electronic device capable of communicating with server 130 via network 102. User computing device 110 may include internal and external hardware components, as depicted and described in further detail below with reference to FIG. 4. In other embodiments, user computing device 110 may be implemented in a cloud computing environment, as described in relation to FIGS. 5 and 6, herein. User computing device 110 may also have wireless connectivity capabilities allowing the user computing device 110 to communicate with server 130, as well as other computers or servers over network 102.

In an exemplary embodiment, user interface 112 may be a computer program that allows a user to interact with user computing device 110 and other connected devices via network 102. For example, user interface 112 may be a graphical user interface (GUI). In addition to comprising a computer program, user interface 112 may be connectively coupled to hardware components, such as those depicted in FIG. 4, for receiving user input. In an example embodiment, user interface 112 is a web browser, however in other embodiments user interface 112 may be a different program capable of receiving user interaction and communicating with other devices.

In an exemplary embodiment, NLP pipeline 114 is a software application that is capable of receiving, analyzing, and understanding natural language text, both structured and unstructured. In an exemplary embodiment, NLP pipeline 114 comprises dictionaries, rules, statistical models, relational databases, entity identifiers, model annotators, and semantic rules in order to make a meaningful text analysis of data, such as the data contained in documents 134.

With continued reference to FIG. 1, new content identifier program 120 contains instruction sets, executable by a processor, which may be described using a set of functional modules. The functional modules of new content identifier program 120 include annotator module 122, knowledge graph generator module 124, knowledge graphs database 126, knowledge graph comparer module 128, and communication module 129. In an exemplary embodiment, new content identifier program 120 is depicted as a separate program on user computing device 110. In alternative embodiments, new content identifier program 120 may be a separate program contained on NLP pipeline 114 or on another server connected via network 102.

With continued reference to FIG. 1, server 130 contains documents database 132. In exemplary embodiments, server 130 may be a laptop computer, tablet computer, netbook computer, personal computer (PC), a desktop computer, a personal digital assistant (PDA), a smart phone, or any programmable electronic device capable of communicating with user computing device 110 via network 102. While server 130 is shown as a single device, in other embodiments, server 130 may be comprised of a cluster or plurality of computing devices, working together or working separately. Server 130 may be implemented in a cloud computing environment, as described in relation to FIGS. 5 and 6, herein. Server 130 may also have wireless connectivity capabilities allowing it to communicate with user computing device 110, as well as with other computers or servers over network 102.

With continued reference to FIG. 1, documents database 132 contains documents 134. In an exemplary embodiment, documents 134 may be a corpora of documents specific to a particular domain of knowledge, such as oncology, neurology, pediatrics, and so forth. For example, documents 134 may include peer-reviewed research articles, journals, publications, magazine articles, and online blog posts to name a few, for a domain of knowledge. In alternative embodiments, documents 134 may include documents pertaining to legal, financial, and any other subjects. Documents 134 within documents database 132 are digital, or electronic, and may be structured, i.e. include metadata, or unstructured and are typically written in programming languages of common file formats such as .docx, .doc, .pdf, .rtf, .html, etc. In alternative embodiments, documents 134 may include handwritten documents or documents scanned into electronic form which have no associated metadata.

In exemplary embodiments, documents 134 may include a static set of electronic documents or a dynamic set of electronic documents. A static set of electronic documents, for example, may be an online subscription to a scientific journal that contains a finite list of documents for a specific time period (i.e. the number of publications for XYZ scientific journal for March 2018). A dynamic set of electronic documents, on the other hand, may be defined in terms of characteristics of a document, such as “all oncology articles in the Nature journal” or “all articles under a certain directory in a file server”. In exemplary embodiments, the static and dynamic sets of electronic documents may be received from an online source, or any other source such as computers or servers over network 102.

In various embodiments, documents 134 may be stored on user computing device 110 or on other computers or servers over network 102, as a separate database.

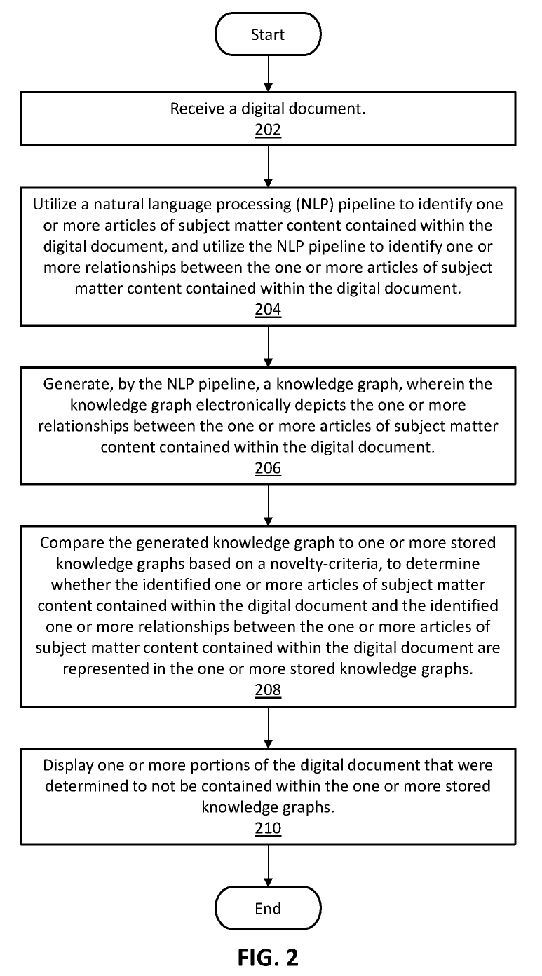

FIG. 2 is a flowchart illustrating the operation of new content identifier program 120, in accordance with an embodiment of the present invention.

Referring now to FIGS. 1 and 2, new content identifier program 120 may electronically identify new content in a digital document. In exemplary embodiments, new content identifier program 120 receives a digital document (step 202). The acquisition mechanism for receiving a digital document is not central to the present invention, however any reasonable push or pull model is sufficient so long as the digital document reaches new content identifier program 120.

In exemplary embodiments, new content identifier program 120 may define a set of digital documents to be utilized by the NLP pipeline 114 to generate a knowledge graph, wherein the set of digital documents comprise any one, or a combination, of the following: a dynamic set of digital documents and a static set of digital documents.

With continued reference to FIGS. 1 and 2, annotator module 122 includes a set of programming instructions in new content identifier program 120. The set of programming instructions is executable by a processor. Annotator module 122 utilizes NLP pipeline 114 to identify one or more articles of subject matter content contained within the digital document, and utilizes NLP pipeline 114 to identify one or more relationships between the one or more articles of subject matter content contained within the digital document (step 204).

In exemplary embodiments, annotator module 122 may be trained to identify, and classify, portions of the digital document according to a type system for a domain of knowledge. Identifying and classifying one or more relationships between the one or more articles of subject matter content contained within the digital document may be depicted on a knowledge graph. In alternative embodiments, annotator module 122 may depict the one or more relationships between the one or more articles of subject matter content contained within the digital document as a table of entities and a table of relations between the entities.

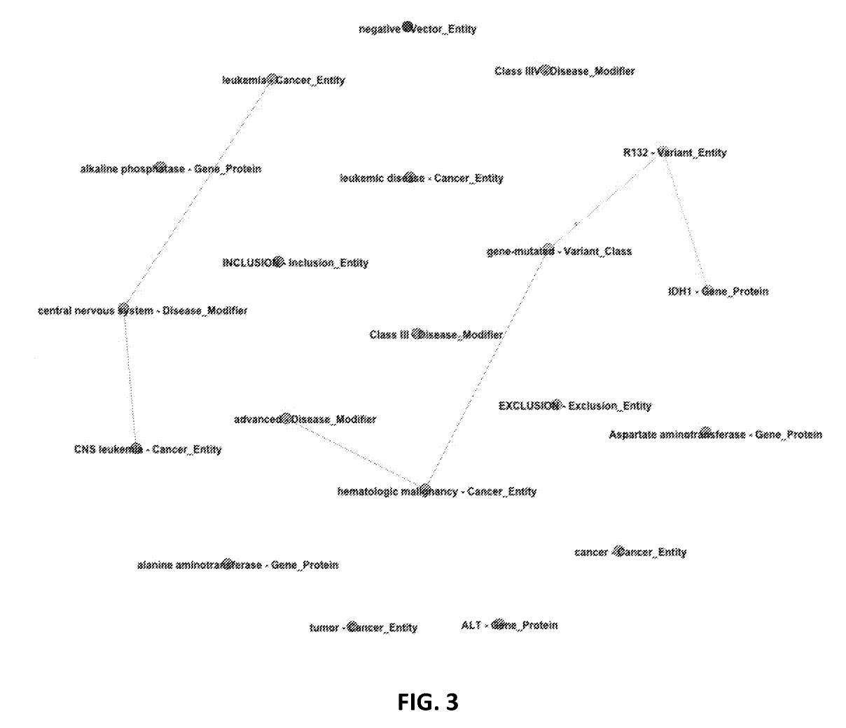

FIG. 3 depicts an illustrative example knowledge graph, in accordance with an embodiment of the present invention.

Referring now to FIGS. 1-3, new content identifier program 120 may receive a peer-reviewed oncology article from a scientific journal. Annotator module 122 may be previously trained to identify one or more articles of subject matter content contained within the digital oncology article, such as <variant_entity>, <gene_protein>, <variant_class>, <disease_modifier>, and other types of subject matter content depicted in FIG. 3.

With reference to the illustrative example of FIG. 3, annotator module 122 is capable of identifying “R132” in the text of the oncology article as <variant_entity>, “IDH1” as <gene_protein>, “gene-mutated” as <variant_class>, “Class IIIV” as <disease_modifier>, just to name a few.

Referring back to FIGS. 1 and 2, knowledge graph generator module 124 includes a set of programming instructions in new content identifier program 120. The set of programming instructions is executable by a processor. Knowledge graph generator module 124 generates, by NLP pipeline 114, a knowledge graph, wherein the knowledge graph electronically depicts the one or more relationships between the one or more articles of subject matter content contained within the digital document (step 206). In exemplary embodiments, knowledge graph generator module 124 generates a knowledge graph for each digital document that is received by new content identifier program 120, and stores the generated knowledge graph in knowledge graphs database 126.

In various embodiments, the one or more stored knowledge graphs may represent a pre-defined set of digital documents that include a same domain knowledge as the generated knowledge graph. In further embodiments, the pre-defined set of digital documents are customizable by a user.

With continued reference to the illustrative example of FIG. 3, the identified article of subject matter content (e.g. “IDH1”), and its associated class type (e.g. <gene_protein>) is depicted on the knowledge graph, together with a line that connects one or more articles of subject matter content (e.g. “R132”, <variant_entity>; “gene mutated”, <variant_class>) that leads to a medical diagnosis (e.g. “hematologic malignancy”, <cancer_entity>).

With continued reference to FIG. 1, knowledge graphs database 126 may include one or more previously generated knowledge graphs pertaining to a digital document within a set of static or dynamic document sets. A generated knowledge graph may represent one or more articles of subject matter content contained within the digital document, together with one or more relationships between the one or more articles of subject matter content contained within the digital document by means of nodes and edges.

In exemplary embodiments and with reference to the illustrative example of FIG. 3, nodes represent articles of subject matter content within the digital document (e.g. “Aspartate aminotransferase”, <gene_protein>; “cancer”, <cancer_entity>, etc.) and edges represent the connections, or relationships, between the articles of subject matter content within the digital document (e.g. “IDH1”, <gene_protein>may lead to “hematologic malignancy”, <cancer_entity>).

In alternative embodiments, stronger relationships between one or more entities may be depicted by a number value along the edges of a generated knowledge graph. For example, a “5” may represent a strong connection based on the number of times the article of subject matter content, and its corresponding relationships with other articles of subject matter content, are found within a received digital document. A “1”, on the other hand, may represent a weak connection based on a low count of the article of subject matter content, and its corresponding relationships with other articles of subject matter content, are found within the received digital document.

In various embodiments, a knowledge graph may acquire and integrate information into an ontology and apply a reasoner to derive new knowledge. An ontology is typically based on logical formalisms which support some form of inference, thereby allowing implicit information to be derived from explicitly asserted data. Knowledge graphs allow for the application of various graph-computing techniques and algorithms (e.g. shortest path computations, network analysis, etc.) which add additional intelligence over the stored data, and can support a continuously running data pipeline that keeps adding new knowledge to the graph, refining it as new information arrives.

In exemplary embodiments, knowledge graphs database 126 is stored on new content identifier program 120 and may be organized by a user identification, domain type, type of file, or in any other fashion deemed most useful for the invention to be utilized.

In alternative embodiments, knowledge graphs database 126 may be stored locally on user computing device 110 as a separate database, or on another computer or server over network 102.

With continued reference to FIGS. 1 and 2, knowledge graph comparer module 128 includes a set of programming instructions in new content identifier program 120. The set of programming instructions is executable by a processor. Knowledge graph comparer module 128 compares the generated knowledge graph to one or more stored knowledge graphs based on a novelty-criteria, to determine whether the identified one or more articles of subject matter content contained within the digital document and the identified one or more relationships between the one or more articles of subject matter content contained within the digital document are represented in the one or more stored knowledge graphs (step 208).

In exemplary embodiments, knowledge graphs comparer module 128 may be capable of providing a user interface (UI) that allows a user to customize the novelty-criteria, wherein the novelty-criteria comprises any one, or a combination, of the following: a pre-defined number of the one or more articles of subject matter content contained within the digital document, a pre-defined number of the one or more relationships between the one or more articles of subject matter content contained within the digital document, and a pre-defined number of the one or more portions of the digital document that were determined to not be contained within the one or more stored knowledge graphs.

In alternative embodiments, knowledge graphs comparer module 128 may be capable of determining new articles of subject matter content contained within a new digital document and/or new relationships between articles of subject matter content contained within a new digital document, by comparing a generated knowledge graph to one or more stored knowledge graphs of the same domain type.

Referring back to the illustrative example of FIG. 3, knowledge graph comparer module 128 is capable of comparing the generated knowledge graph of FIG. 3 with one or more knowledge graphs stored in knowledge graphs database 126. If the stored knowledge graphs in database 126 do not include the identified relationships of the articles of subject matter content contained within a digital document that relate IDH1→R132→gene mutated→hematologic malignancy, then new content identifier program 120 determines that this identified relationship is new and ought to be presented to a user to expand his/her knowledge base in this domain of knowledge.

In exemplary embodiments, knowledge graph comparer module 128 may incorporate, into the one or more stored knowledge graphs, the one or more portions of the digital document that were determined to not be contained within the one or more stored knowledge graphs.

In exemplary embodiments, the stored knowledge graphs may be specific to a user in order to aid in the user's personal education. In alternative embodiments, the stored knowledge graphs may be tailored to a training corpus including a group of users, in order to further the knowledge bases of the corpus of information.

With continued reference to FIGS. 1 and 2, communication module 129 includes a set of programming instructions in new content identifier program 120. The set of programming instructions is executable by a processor. Communication module 129 displays one or more portions of the digital document that were determined to not be contained within the one or more stored knowledge graphs (step 210).

In various embodiments, communication module 129 may require a pre-defined threshold of new content within a digital document prior to presenting the new content to a user. For example, a user may indicate under which conditions he/she wants to be notified about new content within a digital document, relative to one or more pre-defined document sets, such as “when there are 4 or more unique new articles of subject matter content”.

In other embodiments, a user may customize communication module 129 based on when specific articles of subject matter content, together with specific relationships between the identified articles of subject matter content within a digital document, are identified.

In exemplary embodiments, communication module 129 is capable of sending an electronic notification to a user with a link to the digital document containing the one or more portions of the digital document that were determined to not be contained within the one or more stored knowledge graphs.

With reference to the illustrative example of FIG. 3, a user may customize communication module 129 to notify the user if a new cancer type is found in association with gene “IDH1” when that gene is associated with variant “R132”, via sending an electronic notification to the user with a link to the digital document containing the new content.

In the example embodiment, network 102 is a communication channel capable of transferring data between connected devices and may be a telecommunications network used to facilitate telephone calls between two or more parties comprising a landline network, a wireless network, a closed network, a satellite network, or any combination thereof. In another embodiment, network 102 may be the Internet, representing a worldwide collection of networks and gateways to support communications between devices connected to the Internet. In this other embodiment, network 102 may include, for example, wired, wireless, or fiber optic connections which may be implemented as an intranet network, a local area network (LAN), a wide area network (WAN), or any combination thereof. In further embodiments, network 102 may be a Bluetooth network, a WiFi network, or a combination thereof. In general, network 102 can be any combination of connections and protocols that will support communications between user computing device 110 and server 130.

FIG. 4 is a block diagram depicting components of a computing device in accordance with an embodiment of the present invention. It should be appreciated that FIG. 4 provides only an illustration of one implementation and does not imply any limitations with regard to the environments in which different embodiments may be implemented. Many modifications to the depicted environment may be made.

Computing device of FIG. 4 may include one or more processors 902, one or more computer-readable RAMs 904, one or more computer-readable ROMs 906, one or more computer readable storage media 908, device drivers 912, read/write drive or interface 914, network adapter or interface 916, all interconnected over a communications fabric 918. Communications fabric 918 may be implemented with any architecture designed for passing data and/or control information between processors (such as microprocessors, communications and network processors, etc.), system memory, peripheral devices, and any other hardware components within a system.

One or more operating systems 910, and one or more application programs 911, such as new content identifier program 120, may be stored on one or more of the computer readable storage media 908 for execution by one or more of the processors 902 via one or more of the respective RAMs 904 (which typically include cache memory). In the illustrated embodiment, each of the computer readable storage media 908 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Computing device of FIG. 4 may also include a R/W drive or interface 914 to read from and write to one or more portable computer readable storage media 926. Application programs 911 on computing device may be stored on one or more of the portable computer readable storage media 926, read via the respective R/W drive or interface 914 and loaded into the respective computer readable storage media 908.

Computing device of FIG. 4 may also include a network adapter or interface 916, such as a TCP/IP adapter card or wireless communication adapter (such as a 4G wireless communication adapter using OFDMA technology). Application programs 911 on computing device of FIG. 4 may be downloaded to the computing device from an external computer or external storage device via a network (for example, the Internet, a local area network or other wide area network or wireless network) and network adapter or interface 916. From the network adapter or interface 916, the programs may be loaded onto computer readable storage media 908. The network may comprise copper wires, optical fibers, wireless transmission, routers, firewalls, switches, gateway computers and/or edge servers.

Computing device of FIG. 4 may also include a display screen 920, a keyboard or keypad 922, and a computer mouse or touchpad 924. Device drivers 912 interface to display screen 920 for imaging, to keyboard or keypad 922, to computer mouse or touchpad 924, and/or to display screen 920 for pressure sensing of alphanumeric character entry and user selections. The device drivers 912, R/W drive or interface 914 and network adapter or interface 916 may comprise hardware and software (stored on computer readable storage media 908 and/or ROM 906).

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 5, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; analytics services 96, including those described in connection with FIGS. 1-6.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method for electronically identifying new content in a digital document, comprising:
receiving a digital document;
utilizing a natural language processing (NLP) pipeline to identify one or more articles of subject matter content contained within the digital document, and utilizing the NLP pipeline to identify one or more relationships between the one or more articles of subject matter content contained within the digital document;
generating, by the NLP pipeline, a knowledge graph, wherein the knowledge graph electronically depicts the one or more relationships between the one or more articles of subject matter content contained within the digital document;
comparing the generated knowledge graph to one or more stored knowledge graphs based on a novelty-criteria, to determine whether the identified one or more articles of subject matter content contained within the digital document and the identified one or more relationships between the one or more articles of subject matter content contained within the digital document are represented in the one or more stored knowledge graphs; and
displaying one or more portions of the digital document that were determined to not be contained within the one or more stored knowledge graphs.

2. The computer-implemented method of claim 1, further comprising:
defining a set of digital documents to be utilized by the NLP pipeline to generate the knowledge graph, wherein the set of digital documents comprise any one, or a combination, of the following: a dynamic set of digital documents and a static set of digital documents.

3. The computer-implemented method of claim 1, wherein the one or more stored knowledge graphs represent a pre-defined set of digital documents that include a same domain knowledge as the generated knowledge graph.

4. The computer-implemented method of claim 3, wherein the pre-defined set of digital documents are customizable by a user.

5. The computer-implemented method of claim 1, further comprising:
incorporating, into the one or more stored knowledge graphs, the one or more portions of the digital document that were determined to not be contained within the one or more stored knowledge graphs.

6. The computer-implemented method of claim 5, further comprising:
sending an electronic notification to a user with a link to the digital document containing the one or more portions of the digital document that were determined to not be contained within the one or more stored knowledge graphs.

7. The computer-implemented method of claim 1, further comprising:
providing a user interface (UI) that allows a user to customize the novelty-criteria, wherein the novelty-criteria comprises any one, or a combination, of the following: a pre-defined number of the one or more articles of subject matter content contained within the digital document, a pre-defined number of the one or more relationships between the one or more articles of subject matter content contained within the digital document, and a pre-defined number of the one or more portions of the digital document that were determined to not be contained within the one or more stored knowledge graphs.

8. A computer program product, comprising a non-transitory tangible storage device having program code embodied therewith, the program code executable by a processor of a computer to perform a method, the method comprising:
receiving a digital document;
utilizing a natural language processing (NLP) pipeline to identify one or more articles of subject matter content contained within the digital document, and utilizing the NLP pipeline to identify one or more relationships between the one or more articles of subject matter content contained within the digital document;
generating, by the NLP pipeline, a knowledge graph, wherein the knowledge graph electronically depicts the one or more relationships between the one or more articles of subject matter content contained within the digital document;
comparing the generated knowledge graph to one or more stored knowledge graphs based on a novelty-criteria, to determine whether the identified one or more articles of subject matter content contained within the digital document and the identified one or more relationships between the one or more articles of subject matter content contained within the digital document are represented in the one or more stored knowledge graphs; and
displaying one or more portions of the digital document that were determined to not be contained within the one or more stored knowledge graphs.

9. The computer program product of claim 8, further comprising:
defining a set of digital documents to be utilized by the NLP pipeline to generate the knowledge graph, wherein the set of digital documents comprise any one, or a combination, of the following: a dynamic set of digital documents and a static set of digital documents.

10. The computer program product of claim 8, wherein the one or more stored knowledge graphs represent a pre-defined set of digital documents that include a same domain knowledge as the generated knowledge graph.

11. The computer program product of claim 10, wherein the pre-defined set of digital documents are customizable by a user.

12. The computer program product of claim 8, further comprising:
incorporating, into the one or more stored knowledge graphs, the one or more portions of the digital document that were determined to not be contained within the one or more stored knowledge graphs.

13. The computer program product of claim 12, further comprising:
sending an electronic notification to a user with a link to the digital document containing the one or more portions of the digital document that were determined to not be contained within the one or more stored knowledge graphs.

14. The computer program product of claim 8, further comprising:
providing a user interface (UI) that allows a user to customize the novelty-criteria, wherein the novelty-criteria comprises any one, or a combination, of the following: a pre-defined number of the one or more articles of subject matter content contained within the digital document, a pre-defined number of the one or more relationships between the one or more articles of subject matter content contained within the digital document, and a pre-defined number of the one or more portions of the digital document that were determined to not be contained within the one or more stored knowledge graphs.

15. A computer system, comprising:
one or more computer devices each having one or more processors and one or more tangible storage devices; and
a program embodied on at least one of the one or more storage devices, the program having a plurality of program instructions for execution by the one or more processors, the program instructions comprising instructions for:
receiving a digital document;
utilizing a natural language processing (NLP) pipeline to identify one or more articles of subject matter content contained within the digital document, and utilizing the NLP pipeline to identify one or more relationships between the one or more articles of subject matter content contained within the digital document;
generating, by the NLP pipeline, a knowledge graph, wherein the knowledge graph electronically depicts the one or more relationships between the one or more articles of subject matter content contained within the digital document;
comparing the generated knowledge graph to one or more stored knowledge graphs based on a novelty-criteria, to determine whether the identified one or more articles of subject matter content contained within the digital document and the identified one or more relationships between the one or more articles of subject matter content contained within the digital document are represented in the one or more stored knowledge graphs; and
displaying one or more portions of the digital document that were determined to not be contained within the one or more stored knowledge graphs.

16. The computer system of claim 15, further comprising:
defining a set of digital documents to be utilized by the NLP pipeline to generate the knowledge graph, wherein the set of digital documents comprise any one, or a combination, of the following: a dynamic set of digital documents and a static set of digital documents.

17. The computer system of claim 15, wherein the one or more stored knowledge graphs represent a pre-defined set of digital documents that include a same domain knowledge as the generated knowledge graph.

18. The computer system of claim 17, wherein the pre-defined set of digital documents are customizable by a user.

19. The computer system of claim 15, further comprising:
incorporating, into the one or more stored knowledge graphs, the one or more portions of the digital document that were determined to not be contained within the one or more stored knowledge graphs.

20. The computer system of claim 19, further comprising:
sending an electronic notification to a user with a link to the digital document containing the one or more portions of the digital document that were determined to not be contained within the one or more stored knowledge graphs.
